(19) United States
(12) Patent Application Publication
(10) Pub. No.: US 2012/0134064 A1
(43) Pub. Date: May 31, 2012

(54) Solid-state magnet controller for use with an alternating current generator

(76) Inventor: Michael Allen Weed, Spring Valley, MN (US)

(21) Appl. No.: 12/927,863

(22) Filed: Nov. 29, 2010

(51) Int. Cl. H01F 13/00; H01H 47/00

(52) U.S. Cl. 361/144; 361/211

(57) ABSTRACT

A solid-state magnet controller powered by an AC generator using separate silicon controlled rectifier (SCR) bridges to drive current through the magnet in opposite directions. The invention eliminates high voltage transients, first by switching flyback diodes across the magnet using solid state devices, then employing secondary discharge methods to dissipate the remaining stored magnetic energy. Isolated DC-to-DC converters are used as a means of providing drive signals to the solid-state elements. A method to prevent inadvertent FET turn-on is included, as well as a method to slowly decrease the magnet current when desired.

### CROSS-REFERENCE TO RELATED APPLICATIONS

Not applicable.

### STATEMENT REGARDING FEDERALLY SPONSORED RESEARCH OR DEVELOPMENT

This invention was not made under Federally sponsored research or development.

REFERENCE TO SEQUENCE LISTING, A TABLE, OR A COMPUTER LISTING COMPACT DISC APPENDIX

Not applicable.

### BACKGROUND OF THE INVENTION

A direct current (DC) is applied to a lifting magnet attached by mechanical means to a boom to attract and hold ferrous metals. The magnet is then moved to another location and the current is removed from the magnet coil to release the metal. However, the magnet core is not completely demagnetized when all the current is removed, so some amount of current must be applied for some period of time in a direction opposite to the original current flow to release all the metal. This results in a “clean drop”.

Most prior magnet controllers have been powered by DC generators. A few have used AC generators which convert the AC to DC by conventional bridge rectifiers, then this DC was used as if from a DC generator. Originally a mechanical contact arrangement was employed to apply and reverse the magnet current. These contacts were expensive and needed frequent replacement. More recently, solid state switching devices have been used in an “H” bridge configuration to drive current from the DC source in one direction for the “lift” phase, then in the other direction for the “drop” phase. This required four solid-state devices of high current carrying capacity and capable of withstanding the voltages involved, usually 230 Volts DC. A small magnet may draw 15 Amperes while a large magnet may draw 80 Amps or more.

An industrial lifting magnet has an inductance L and a resistance R. The resistance and inductance are distributed throughout the length of the coil, but the magnet is electrically equivalent to a resistance in series with a purely inductive element. If a magnet having initial current I(0) is shorted out the current as a function of time is I(t)=I(0)exp(−Rt/L). In other words, the current in a magnet has a characteristic period of L/R. The value of L/R for industrial lifting magnets is typically about 0.5 seconds

Reversing the current in the magnet is one problem, and another major problem occurs when the current in the magnet coil is reduced. A “back EMF” E=−LdI/dt is produced due to the inductance L, where dI/dt is the rate of current change with time. This voltage transient can be very large, and will damage semiconductor switching devices if not controlled.

It is well known that the voltage transient caused by reducing the current in an inductor can be suppressed by placing a “flyback diode” across the inductor, but such a diode cannot be used in a magnet controller because the diode would short out the generator when the current is reversed.

One means of mitigating this problem is to reverse the field of a DC generator and thereby reverse the output, but the field is also an inductor, so transient suppression is still required. Also, reversing the field results in a demagnetization time that is unacceptably long.

Most relevant related U.S. patents:

U.S. Pat. No. 4,306,268—Essentially an H bridge with relays for switching a DC source, but had a forward flyback diode in series with resistors permanently connected across the magnet, which would have conducted heavily during reverse. Another flyback diode for reverse, again in series with a resistor, was switched in using relays. Voltage drop on these resistors represented the decaying current in the magnet, and when the current was low enough, reverse voltage from the DC source began flowing into the magnet via a diode that kept the source isolated from the magnet up to that point. But voltages reached up to 1000 V, and there must have been severe arcing in the relay contacts.
U.S. Pat. No. 4,600,964—A design using two magnet coils, one for lift and one for drop. This used full-wave rectified output from an AC generator, which was switched between lift and drop coils using relays. The main problem with this invention is that magnets are expensive, and most magnets already in field have only one coil. Flyback diodes on each coil are necessary to prevent arcing when the relay contacts are opened.
U.S. Pat. No. 5,325,260—This design used an AC generator that was connected to a standard bridge rectifier via mechanical relay contacts. The unfiltered DC from the bridge was applied to the magnet using mechanical relays in a standard H bridge configuration. Before the lift or drop relay contacts were opened, the relay contacts feeding the standard rectifier bridge were opened, thus causing the H bridge rectifiers to act like flyback diodes. This reduced the stored magnetic energy before the lift or drop contacts opened, and would reduce the high voltage arcing to some extent. But there was no secondary discharge circuit as in the present invention, and no capacitor across the magnet, which means either there was a large high voltage transient or a relatively long time was required to reverse the magnet current. This was not a solid-state design, and did not use SCRs. Special mercury-wetted relay contacts were required because of the contact arcing.
U.S. Pat. No. 7,495,879—A solid state design that used insulated gate bipolar transistors (IGBTs) in an H bridge configuration and a DC power source. The stored magnetic energy at the end of a lift or drop was fed into a large capacitor, then the capacitor was discharged through a fifth IGBT and resistor. Neither an AC generator nor SCRs were used in this design. To avoid excessive high voltage, the capacitor must have been very large and must have had a rather high voltage rating. The stored magnetic energy was dissipated in a resistor, not the magnet, so the resistor must have been of high wattage rating, and therefore of large physical size and must have required a large heat sink.
U.S. Pat. No. 7,697,253—Another solid-state control using a DC generator and an H bridge configuration. This design dissipated the stored magnetic energy in the DC generator and a resistor in series with a transient voltage supressor (TVS), not in the magnet resistance. This would produce some extra wear on the generator, and would have required a very large TVS to withstand twice the lifting current for at least several tenths of a second.

### SUMMARY OF THE INVENTION

Commonly available AC generators produce either 50 Hertz or 60 Hz. The period of a full-wave rectified single phase 50 Hz signal is 10 milliseconds. The current through a magnet with L/R=0.5 second varies by no more than (1−exp(−0.01/0.5)), or about 2%, when a full-wave rectified 50 Hz voltage is applied, even though the voltage drops to zero every 10 milliseconds. The magnetic field is proportional to the current. The ripple in the unfiltered applied voltage has no significant impact on the performance of the magnet when compared to a DC power source. Application of a rectified three phase or multiphase voltage results in even less ripple current.

The basic idea of the present invention is to full-wave rectify the output of an AC generator using a type of thyristor called a Silicon Controlled Rectifier, or SCR. A SCR is a kind of diode with an additional gate connection. It will conduct electrical current when the voltage is across the SCR in one direction and sufficient (DC) current is flowing between the gate and cathode of the SCR. The use of an AC generator results in much lower cost, greater reliability and less down time for repairs when compared to a DC generator of similar power, as colorfully described in U.S. Pat. No. 5,325,260.

During the “lift” phase, one or more full-wave SCR bridges apply voltage to the magnet in one direction. For the “drop” phase, the gate drive to the forward bridge(s) is removed and gate drive is applied to a separate SCR bridge or set of bridges to drive current through the magnet in the opposite direction. SCRs are generally more rugged and less expensive than other solid state switching devices of comparable power handling capability such as Field Effect Transistors (FETs), Insulated Gate Bipolar Transistors (IGBTs) or Bipolar Junction Transistors (BJTs). However, SCRs have a significant drawback compared to other devices, especially when driving an inductive load such as a magnet, in that a SCR cannot be turned off by removing the gate drive. The SCR turns off only when the current through it drops below the holding current, typically a fraction of an Ampere. Any design using SCRs to drive an inductive load must take this fact into account.

The present invention provides a method of turning off SCRs and suppressing high voltage transients by switching a flyback diode across the magnet at the end of the lift phase, and switching a flyback diode in the opposite direction across the magnet at the end of the drop phase. This dissipates most of the stored magnetic energy in the magnet's resistance. The small amount of energy remaining in the magnet after the flyback diode is switched off charges a capacitor, and this charge is eventually dissipated in the generator. One variation, suitable for magnets drawing more than about 20 Amps during lift, uses both a primary and secondary circuit to dissipate the stored magnetic energy before charging the capacitor. During the secondary discharge, most of the remaining stored magnetic energy is dissipated in a resistor that is switched in series with the magnet. FETs are used as the switching elements for dissipating the stored energy in the preferred embodiment of the invention, but IGBTs or BJTs could also be used.

The voltages between the various semiconductor elements are at widely different values during operation, so an isolated power source is needed to drive each FET and each SCR. Isolated current sources to drive the SCR gates and isolated voltage sources to drive the FET gates are obtained by a novel use of low power DC-to-DC converters. A special gate clamp circuit is described that prevents a FET from inadvertently turning on. Also described is a method of slowly reducing the magnet current, called a “dribble” mode, that uses a pulse-width modulated drive on the generator field in conjunction with signals to the solid-state elements.

### BRIEF DESCRIPTION OF THE DRAWINGS

FIG. 1A shows the SCR section of the magnet controller if the source of power is a single phase AC generator.

FIG. 1B shows the SCR section of the magnet controller if the source of power is a single-output three phase AC generator.

FIG. 1C shows the SCR section of the magnet controller if the source of power is an AC generator with dual independent three phase outputs.

FIG. 2A shows one method of providing isolated gate current to a SCR using an isolated DC-to-DC converter and a Field Effect Transistor as a switching element.

FIG. 2B shows an alternative method of providing isolated gate current to a SCR using an isolated DC-to-DC converter and a Bipolar Junction Transistor as a switching element.

FIG. 2C shows one method of providing isolated gate voltage to a Field Effect Transistor using an isolated Field Effect Transistor as a switching element.

FIG. 2D shows an alternative method of providing isolated gate voltage to a Field Effect Transistor using a Bipolar Junction Transistor as a switching element.

FIG. 3 shows a gate clamp circuit to prevent inadvertent turn-on of a FET.

FIG. 4 shows a method of controlling the output voltage of an AC generator by applying a pulse-width modulated (PWM) signal to the field coil of the generator.

FIG. 5 shows the circuit for discharging the stored magnetic energy suitable for magnets drawing less than about 20 Amps.

FIG. 6 shows the circuit for discharging the stored magnetic energy suitable for magnets drawing more than about 20 Amps.

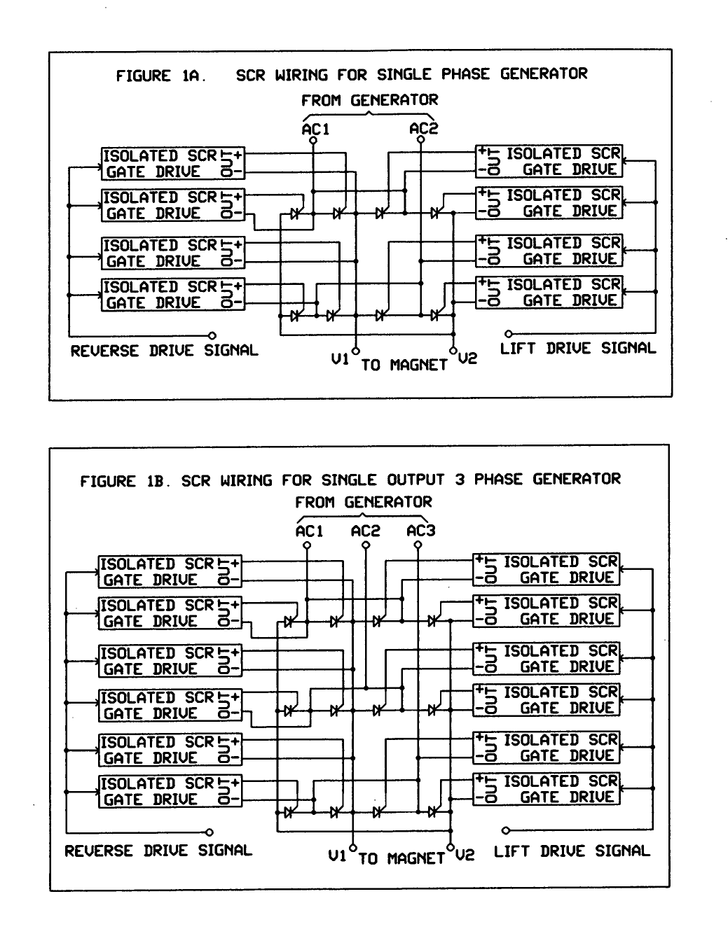

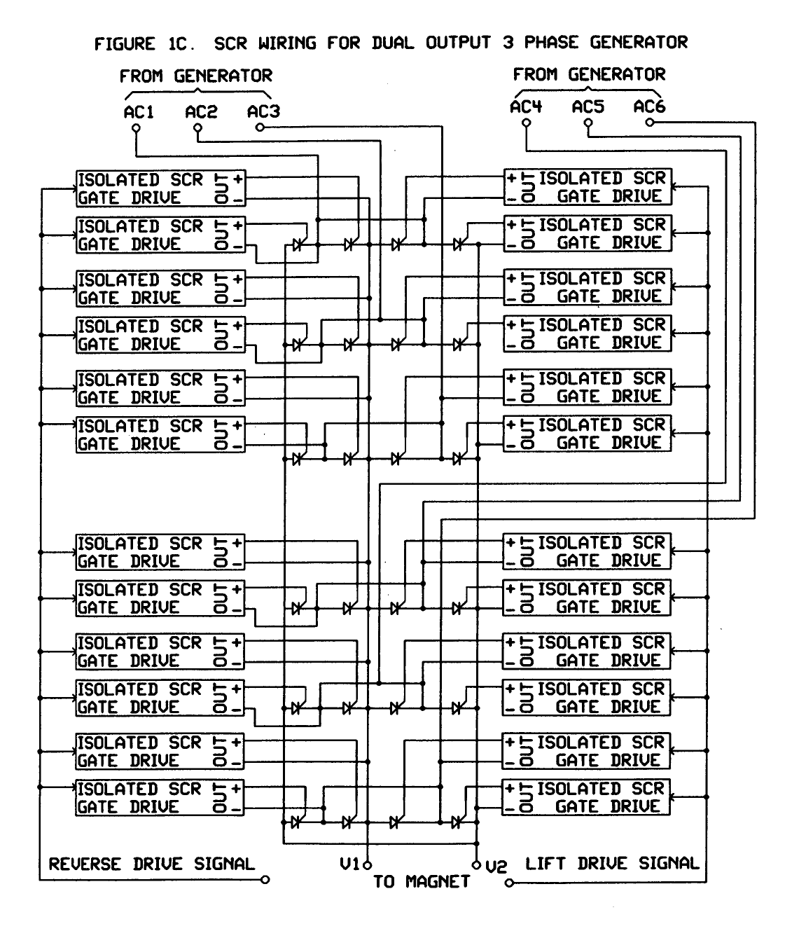

### DETAILED DESCRIPTION OF THE INVENTION

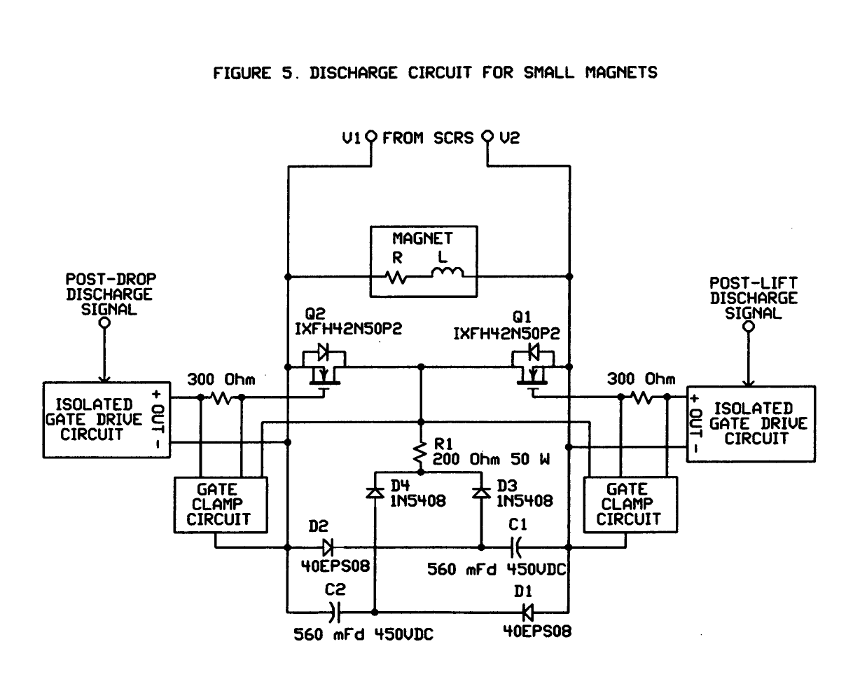

In the initial state, no drive signals are applied to the SCRs or FETs and there is no current in the magnet. The operator signals the controller for a “lift” by, for example, pressing a pushbutton. The control circuit responds by applying gate drive to all the SCRs in the “forward” bridge(s). These SCRs then act like ordinary diodes that provide full-wave rectified power to the magnet, with a small ripple current. The current in the magnet builds up to its maximum value I(0)=V/R for applied voltage V and magnet resistance R and attracts the load. The operator moves the magnet to the drop location and signals the controller to release the load, for example, by pressing a pushbutton. Referring to FIG. 5, at this time the controller removes the gate drive from the “lift” SCRs and turns on Q1. Q1 will conduct current through the body diode of Q2 when voltage at V1 is more positive than the voltage at V2, but V1 is more negative than V2 while the lift SCRs remain on. Thus, the generator is not shorted out by Q1 while one pair of SCRs (one driving V1 negative, the other driving V2 positive) are conducting. Because AC voltage is applied to the SCRs, and they now have no gate drive, the voltage across the conducting SCRs will reverse within one half of a cycle of the AC power, and the conducting SCRs will turn off. At this point, current is no longer being applied to the magnet, and the magnetic field begins to collapse. The magnet becomes a source of current that is now in a direction that can flow through Q1 and the body diode of Q2, which acts as a flyback diode. Thus, there is no high voltage transient. The magnet current decays according to

I(t)=I(0)exp(−Rt/L), and decays to I1=0.1361(0) after one second if L/R=0.5 second. The stored magnetic energy is dissipated in the magnet's resistance, and because the stored magnetic energy is proportional to the square of the current, approximately 98% of the energy is dissipated in this one second interval. During this time, the capacitors shown in FIG. 5 are discharged to near zero volts through the 200 ohm resistor, which is included to limit the current from the capacitors that flows through Q1.

FIG. 5 shows polarized capacitors with steering diodes that prevent reverse voltage across the capacitors, and additional diodes and a resistor to discharge the capacitors. This arrangement could be replaced by a single AC capacitor, but an AC capacitor of sufficient size would be extremely expensive and bulky. Transistor Q1 is turned off after one second, and there is essentially no charge on the capacitors at this time, but some magnetic energy remains in the magnet and the magnet is still producing a current I1. With the SCRs and Q1 and Q2 turned off, the circuit is a series LRC configuration. The sum of the voltages around this closed circuit is zero. If Q is the charge on the capacitor, the circuit equation is LdI/dt+RdQ/dt+Q/C=0 where I=dQ/dt. The solution to this second-order differential equation is Q(t)=exp(−Rt/2L)(A cos(wt)+B sin(wt)) where A and B are constants determined by the initial conditions and w=squareroot(1/LC−(R/2L)(R/2L)) radians per second (provided squareroot(LC)<2L/R, as it is for practical values of C). Here t=0 is taken as the time when Q1 is turned off. Since Q(0)=0, it must be that A=0. The current in the circuit is I(t)=dQ/dt=B exp(−Rt/2L)(−(R/2L)sin(wt)+w cos(wt)). Hence, B=I1/w and Q(t)=(I1/w)exp(−Rt/2L)sin(wt). The voltage across the capacitor is V(t)=Q(t)/C=(I1/wC)exp(−Rt/2L)sin(wt), an exponentially damped oscillation.

For industrial lifting magnets and practical values of C, w is nearly squareroot(1/LC) and is much larger than 2L/R, and the voltage across the capacitor peaks when the argument of the sine is pi/2 radians. For example, a relatively small magnet with I(0)=20 Amps has I1=2.72 Amps. If C=560 microFarads (mFd) and L=5 Henries, the voltage peaks 83.2 milliseconds after Q1 is turned off, and the peak voltage is 257 Volts. This is less than the peak voltage of the rectified AC applied during lift, so there is no high voltage transient.

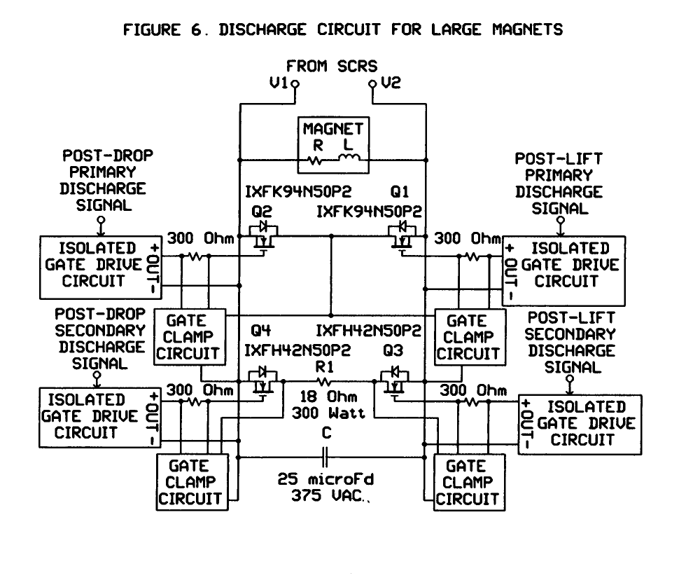

However, a large magnet may have I(0)=80 Amps and I1=10.9 Amps, which, with the same C, would produce an excessive peak voltage of 1028 Volts. This could be mitigated by using even larger capacitors, but a less expensive solution may be afforded by the circuit shown in FIG. 6. Here, as above, the magnet has a flyback diode applied by Q1 for one second after the SCRs are turned off, but then Q1 is turned off and a secondary discharge circuit consisting of Q3, R1 and the body diode of Q4 is connected across the magnet for a period of ½ second. If there were no capacitor across the magnet during this secondary discharge, the current during this time would be I(t)=I1 exp(−(R1+R)t/L). It seems counterintuitive, but the magnet actually discharges faster when a larger resistor is placed across it. The voltage across the magnet at the start of the discharge would be I1R1. For example, if R1=18 Ohms and I1=10.9 Amps, the peak voltage would be a modest 196 Volts. However, the addition of a capacitor across the magnet as shown in FIG. 6 considerably reduces this peak voltage, so there is no high voltage transient. If the RC time constant is much less than the L/(R+R1) time constant, the presence of the capacitor does not significantly alter the exponential decay of the voltage due to L and R+R1. For example, if L/R=0.5 seconds, R=4 Ohms and R1=18 Ohms, the current in the magnet is reduced by a factor of e to the power 5.5 after ½ second. In the present example, this is I2=I1/245=0.045 Amps. During this ½ second, most of the remaining magnetic energy is dissipated in R1, which must be of sufficient wattage to handle the initial current of 10.9 Amps and the average power over the ½ second period.

At the end of the secondary discharge, Q3 is turned off and the circuit now appears as a series LRC circuit like the circuit of FIG. 5 at the end of the primary discharge, but now the initial current is much smaller, and a much smaller single AC capacitor can be used across the magnet without the need for steering and discharge diodes. The capacitor voltage at this time is 0.045 Amps times 18 Ohms, or 0.81 V, which is added to the peak voltage of the exponentially decaying sinusoidal waveform. For a typical large magnet with R=4 Ohms and L=2 Henries, and using C=25 microFarads, the voltage peak occurs 10.2 milliseconds after Q3 is turned off, and the peak voltage is 13.5 Volts. There is no high voltage transient. Of course, the circuit of FIG. 6 could also be used for small magnets instead of the circuit in FIG. 5; the choice is only a matter of cost.

Once the discharge circuits are turned off after a lift, the SCRs for reverse mode may be turned on without shorting out the generator. After the peak voltage has passed, the reverse SCRs begin driving current to the magnet in the reverse direction. The remaining magnetic energy after the discharge phase is stored in the capacitor, and this energy is dissipated in the generator when the reverse SCRs begin to conduct. Reverse current is driven through the magnet for a time (selected by the operator) until the magnet is fully demagnetized. The time needed depends on the specific magnet and generator. At the completion of the drop phase, the magnet must be discharged again in the same manner as after the lift phase. As can be seen in FIGS. 5 and 6, the circuit is completely symmetric with respect to positive or negative voltage on the magnet, so the discharge sequences are identical with the roles of Q1 and Q2 reversed, and the roles of Q3 and Q4 reversed in the circuit of 6.

As described above, forward and reverse voltages are applied to the magnet using SCRs instead of other possible switching elements to improve reliability and minimize cost. However, the discharge circuits require FETs, which can be switched off at any time, unlike SCRs that can be turned off only by removing their supply current. The primary discharge FETs must be able to handle the peak magnet current, but the secondary discharge FETs can have a much lower current rating. None of the FETs are on for more than one second at a time, so their power rating can be much less than if they were used as primary switching elements. Only two FETs are needed in the circuit of FIG. 5, and only four in the circuit of 6. The small number of FETs and their reduced power requirements compared to the H bridge elements of prior art result in lower cost.

In the preferred embodiment of the controller, a microprocessor detects commands from the operator and produces the signals to drive the various switching elements. Modern microprocessors are very inexpensive and can generate control signals with sub-millisecond timing accuracy.

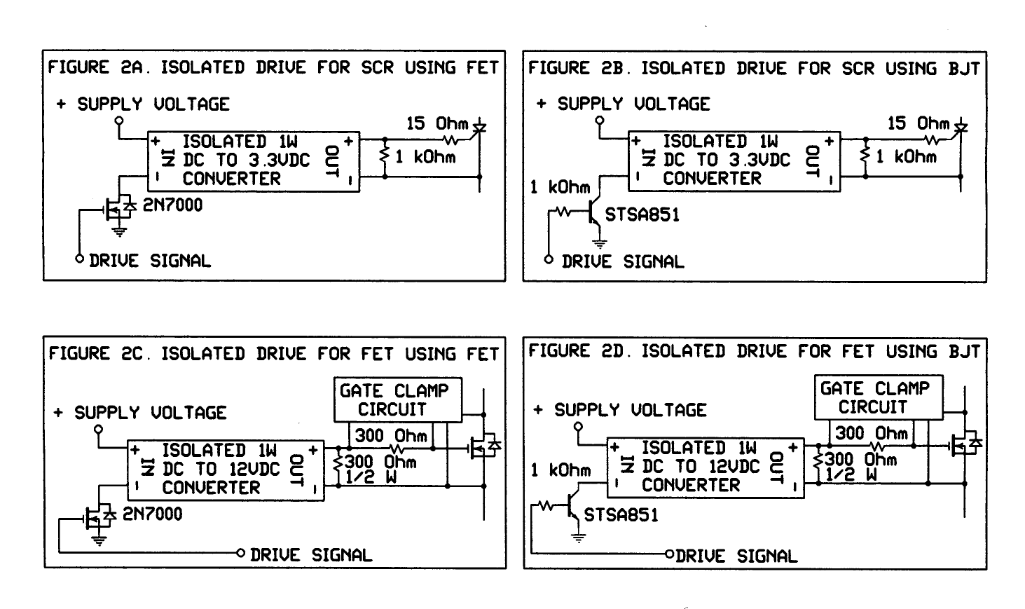

The various switching elements in the controller operate at widely differing voltages, so require electrically isolated drive circuits. Traditional solid-state relays use opto-isolators and elaborate circuitry to turn on the switching element using power from the switched circuit. The recent availability of low cost, low power isolated DC-to-DC converters with the ability to turn on or off in a time on the order of a millisecond has made a different kind of solid-state relay possible, as illustrated in FIGS. 2A, 2B, 2C and 2D. Unlike traditional solid-state relays, this kind requires a specific voltage to power the DC-to-DC converter. The necessary isolation is built into the DC-to-DC converter, which also supplies the drive power to the switched element. For example, FIG. 2A shows how to drive a SCR or other current-controlled device, such as a triac or BJT. If the control circuit operates at 5 volts or more, the control signal can turn on a small FET to apply power to the input of the DC-to-DC converter. For a SCR, the output voltage of the converter can be 3.3V, and a 1 Watt converter can supply 300 milliAmps at this voltage. Even large SCRs seldom require more than 150 milliAmps gate current to turn on, so a 1 Watt converter is adequate. Some control circuits operate at 3.3V or less, which is generally not enough voltage to fully turn on a FET. In these cases, a high-gain bipolar junction transistor with a low collector-to-emitter saturation voltage (to insure nearly full supply voltage is applied to the converter) can be used in place of a FET, as illustrated in FIG. 2B. If the switched element is a device that is voltage-controlled, such as a FET or IGBT the same type of circuit can be used, but with a converter output voltage of 12V or 15V. A FET requires very little gate current to turn on, but needs this higher voltage, which is readily available from a 1 Watt DC-to-DC converter.

FIG. 2C shows how to control a FET if the control circuit operates at 5V or more, so the converter can be switched on or off using a small FET, and FIG. 2D shows how to control a FET using a BJT to switch the converter, in case the control voltage is less than 5V.

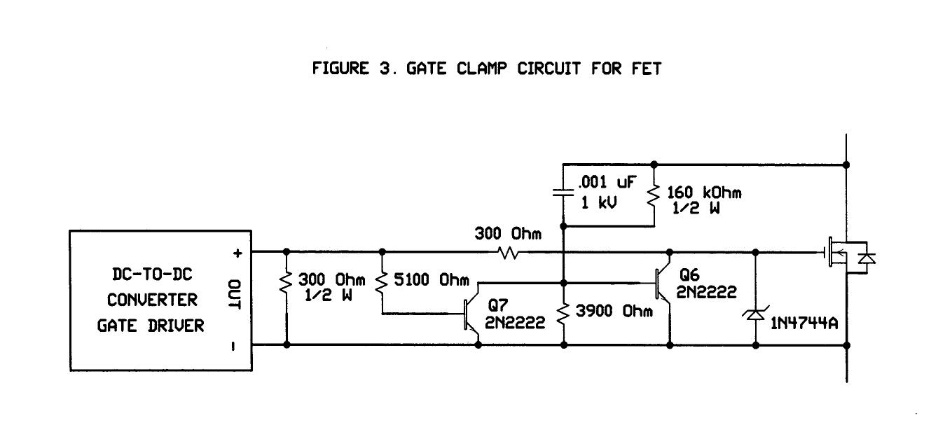

As can be seen in FIGS. 5 and 6, the discharge FETs must remain off when the magnet is lifting or reversing. A problem occurs when the FET is not being driven from its DC-to-DC converter, but the drain voltage rises rapidly relative to the source voltage due to some other influence. In this case, a positive pulse sufficiently large to partially turn on the FET can be coupled to the gate via the drain-to-gate capacitance of the FET. Although the drain-to-source voltage and the drain current may not exceed the FET's ratings, the FET may fail because the product of current and voltage may exceed the power rating of the FET. To avoid this problem, all the FETs in the controller are protected with the gate clamp circuit shown in FIG. 3. When a small bipolar transistor Q6 is turned on, it will short the FET gate to its source, preventing the FET from turning on. The base of Q6 is fed by a 160 kiloOhm resistor from the FET drain, which is bypassed by a 0.001 microFarad capacitor for rapid response, and the base of Q6 is connected to its emitter and the FET source through a 3.9 kOhm resistor. Q6 is turned on when the FET drain rises to more than about 30V above the source. The FET gate is protected from excessive voltage with a Zener diode. However, the FET must be turned on when the DC-to-DC converter is turned on, which means that Q6 must be turned off at this time. This is accomplished with Q7, which turns on when the DC-to-DC converter turns on, connecting the base of Q6 to its emitter, thus disabling the clamp and allowing the FET to turn on.

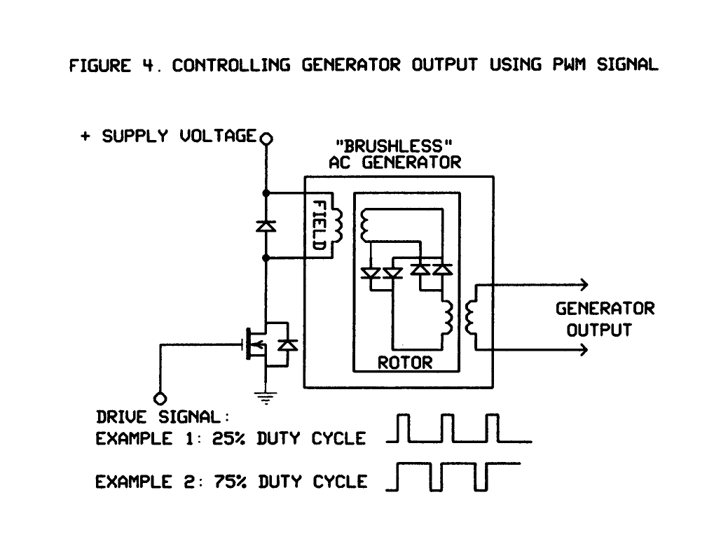

Simple magnet controllers apply either full generator voltage or no voltage to the magnet. More advanced designs allow the operator to control the voltage applied to the magnet. This is useful for operations such as sorting, where reduced magnet voltage will pick up small pieces of metal but leave heavier pieces behind. It is particularly easy to control the output voltage of a brushless AC generator by applying a Pulse Width Modulated (PWM) drive to the generator field, as shown in FIG. 4. A PWM drive switches the field voltage between zero volts and full voltage at a frequency of perhaps several hundred Hertz, so that the field winding (an inductor) “sees” only the average applied voltage.

Pulse Width Modulation is used so that essentially all of the applied power goes into the field, and almost none into the switching element. The frequency of the drive is high enough so that the inductance of the field smoothes out the variations imposed by the switched voltage. Thus the field current remains nearly constant with constant PWM duty cycle, but can be adjusted by varying the duty cycle of the switching waveform. The AC output of the generator is roughly proportional to the average field current. A flyback diode must be connected across the field coil to prevent high voltage transients, but note that reverse field voltage is never applied, so the flyback diode does not short out the drive voltage.

Sometimes it is desired to operate a magnet in a “dribble” mode, where no reverse voltage is applied, but the forward voltage is cut off or reduced slowly so that the metal pieces are allowed to dribble off the magnet as the magnetic field decreases. This is another way of sorting, because the heavier pieces tend to drop off first. A dribble mode can be implemented in the present controller while avoiding high voltage transients, providing that the generator field is driven by a PWM circuit. Referring to FIG. 5, suppose that the forward SCRs are turned on (gate current applied) and FET Q1 is also turned on. As noted above, Q1 does not conduct while the forward SCRs are on, because reverse voltage is applied to the body diode of Q2 in this state. To reduce the magnet voltage to a lower level, but not to zero, the gate drive of the forward SCRs is removed for some period of time, generally in the range of 20 to 100 milliseconds, so that the forward SCRs will turn off. The magnetic field begins to collapse and the current generated by the magnet flows through the body diode of Q2 and through Q1. The magnet is essentially shorted out, so there is no high voltage transient. During the time that the forward SCRs are off, the PWM duty cycle (controlling the average field voltage) is reduced; this reduces the AC voltage output of the generator. After the 20 to 100 millisecond interval, the forward SCRs are turned on again, which again reverse biases the body diode of Q2 and effectively removes the short across the magnet. Now the magnet voltage is at the reduced level which means the lifting power has been reduced. This stepwise reduction can be repeated as desired. The operator can select the dribble rate by varying the SCR off time and/or the amount of duty cycle reduction of the PWM at each step. If desired, the magnet can be cycled through a normal drop sequence at the end of the last dribble step to remove all the remaining pieces from the magnet.

I claim:

1. A lifting magnet system, comprising: an alternating current generator; an electromagnet; one or more full-control silicon controlled rectifier bridges to apply power to the magnet for lifting; one or more full-control silicon controlled rectifier bridges to apply power to the magnet for reversing; a primary discharge means of dissipating a significant part of the stored magnetic energy in the magnet after the lift phase; a separate primary discharge means of dissipating a significant part of the stored magnetic energy in the magnet after the reverse phase; a secondary discharge means of dissipating the remaining stored magnetic energy after the primary discharge of the lift and reverse phases; a logic controller to receive signals from the operator and provide signals at the appropriate times to the other circuits in the controller.

2. The primary discharge means of claim 1 consisting of a switching device in series with a flyback diode across the magnet for discharge after the lift phase, and a separate switching device and flyback diode across the magnet for discharge after the reverse phase.

3. A secondary discharge means of claim 1 consisting of either a non-polarized capacitor across the magnet or a pair of polarized capacitors, in conjunction with steering and discharge diodes across the magnet, such capacitor(s) used to store the remaining energy from the magnetic field collapse until the energy can be dissipated in the generator.

4. An alternative secondary discharge means of claim 1 consisting of switching devices in series with a flyback diode and resistor for discharge after the lift phase primary discharge, and a separate secondary discharge means of claim 1 consisting of a switching device in series with a flyback diode and resistor for discharge after the reverse phase primary discharge.

5. A capacitor across the magnet to store the remaining energy from the magnetic field collapse after application of the discharge means of claim 4 until the remaining energy can be dissipated in the generator.

6. A method of effecting a type of solid-state relay by use of an isolated DC-to-DC converter in conjunction with a solid-state switching device such as a Field Effect Transistor (FET), an Insulated Gate Bipolar Transistor (IGBT), a triac, a Silicon Controlled Rectifier (SCR), or a Bipolar Junction Transistor (BJT), said relay deriving its power from a specific supply voltage but not using power from the switched circuit.

7. A clamping circuit to prevent inadvertent turn-on of the solid state switching devices of claims 2, 3 and 4, consisting of a feedback circuit from the device to a clamp transistor, and an additional transistor to disable the clamp when the switching device is to be turned on.

8. A method whereby the magnet current in the system of claim 1 may be slowly reduced to effect a “dribble” mode by alternately connecting a flyback diode across the magnet and applying a reduced average field voltage to the AC generator in a stepwise fashion.
